(19) United States
(12) Patent Application Publication
(10) Pub. No.: US 2011/0011257 A1
(43) Pub. Date: Jan. 20, 2011

(54) ELECTRO-HYDRAULIC ACTUATOR HAVING END CAP WITH SPLIT BUSHING

(75) Inventor: ANTHONY JAMES CASASSA, Saint Cloud, MN (US)

Correspondence Address: PARKER-HANNIFIN CORPORATION;HUNTER MOLNAR BAKER MORGAN, 6035 PARKLAND BOULEVARD, CLEVELAND, OH, 44124-4141, US

(73) Assignee: PARKER HANNIFIN CORPORATION, CLEVELAND, OH (US)

(21) Appl. No.: 12/504,291

(22) Filed: Jul. 16, 2009

(51) Int. Cl. F15B 15/14

(52) U.S. Cl. 92/165 R

(57) ABSTRACT

An electro-hydraulic actuator includes a hydraulic pump, an electric motor operable for driving the hydraulic pump, a piston/rod assembly that is movable in response to fluid from the hydraulic pump, and a housing. A portion of the housing defines a cylinder bore within which a piston of the piston/rod assembly is located. The electro-hydraulic actuator also includes an end cap for closing an end of the cylinder bore and through which a rod of the piston/rod assembly extends. The end cap includes a bushing for supporting movement of the rod through the end cap. The bushing has an axially extending split and is adapted to be under compression when installed in the end cap.

### TECHNICAL FIELD

The present invention relates to an electro-hydraulic actuator. More particularly, the invention relates to an electro-hydraulic actuator having an end cap with a split bushing.

### BACKGROUND OF THE INVENTION

Electro-hydraulic actuators are generally known. A typical electro-hydraulic actuator includes an electric motor that drives a hydraulic pump to move fluid from a reservoir to a hydraulic actuator for moving a piston/rod assembly of the actuator. When the electric motor is driven in a first rotational direction, the hydraulic fluid moved by the hydraulic pump causes a rod of the actuator to extend out of its housing. When the electric motor is driven in a second rotational direction, opposite the first rotational direction, the hydraulic fluid moved by the hydraulic pump causes the rod of the actuator to retract into its housing. A housing supports the components of the electro-hydraulic actuator. The housing defines a cylinder bore of the actuator within which the piston/rod assembly is moveable. An end cap closes an open end of the cylinder bore of the housing. The end cap supports and seal against the rod, which extends through the end cap.

Unlike actuators used in many industrial and mobile applications, the rod diameter in an electro-hydraulic actuator is often quite small. As a result, forming the end cap with an internal groove for receiving a rod seal is difficult and insertion of a rod seal in such a groove is labor intensive. To overcome these deficiencies, it is common for the end cap of an electro-hydraulic actuators to include a counterbore that extends into one end of the end cap. The rod seal is positioned at the bottom of this counterbore. A thick walled cylindrical nylon bushing is then press fit into the counterbore of the end cap. The thick walled nylon bushing secures the rod seal within the end cap and also functions to support the rod relative to the end cap.

There are occasions when it is desirable to use an electro-hydraulic actuator in a cold weather environment. It is further desirable that, regardless of the environment within which the electro-hydraulic actuator is used, oil leakage through the end cap is prevented. In extreme cold weather, such as temperatures in the range of −10° F. to −40° F., for example, it has been found that oil leakage is common with electro-hydraulic actuators having end caps formed with a thick walled nylon bushing, as described above. The leakage results from the thick walled nylon bushing shrinking (changing dimension as a result of temperature changes) at a greater rate than the end cap. The shrinking of thick walled nylon bushing eliminates the press fit bond between the bushing and the end cap and, results in movement of the bushing with the counterbore. Movement of the thick walled nylon bushing allows the rod seal to move, which thereby affects its sealing engagement with the rod. An electro-hydraulic actuator that overcomes these deficiencies at cold temperatures is desirable.

### SUMMARY OF THE INVENTION

At least one embodiment of the invention provides an electro-hydraulic actuator comprising a hydraulic pump, an electric motor operable for driving the hydraulic pump, a piston/rod assembly that is movable in response to fluid from the hydraulic pump, and a housing. A portion of the housing defines a cylinder bore within which a piston of the piston/rod assembly is located. The electro-hydraulic actuator also includes an end cap for closing an end of the cylinder bore and through which a rod of the piston/rod assembly extends. The end cap includes a bushing for supporting movement of the rod through the end cap. The bushing has an axially extending split and is adapted to be under compression when installed in the end cap.

The end cap may further include a sleeve for supporting the bushing. The bushing, when received in the sleeve, tends to press outwardly against the sleeve. The sleeve may be formed from a material having a coefficient of thermal expansion that is approximately equal to that of the end cap. In one embodiment, both the end cap and the sleeve are aluminum.

### BRIEF DESCRIPTION OF THE DRAWINGS

Embodiments of this invention will now be described in further detail with reference to the accompanying drawings, in which:

FIG. 1 is a perspective view of an electro-hydraulic actuator constructed in accordance with the present invention;

FIG. 2 is an elevation view of the electro-hydraulic actuator of FIG. 1;

FIG. 3 is a cut-away view of the electro-hydraulic actuator of FIG. 1;

FIG. 4 is an assembled view of an end cap of the electro-hydraulic actuator of the FIG. 1;

FIG. 5 is an exploded, perspective view of the end cap of FIG. 4; and

FIG. 6 is a schematic illustration of the electro-hydraulic actuator of FIG. 1.

### DETAILED DESCRIPTION

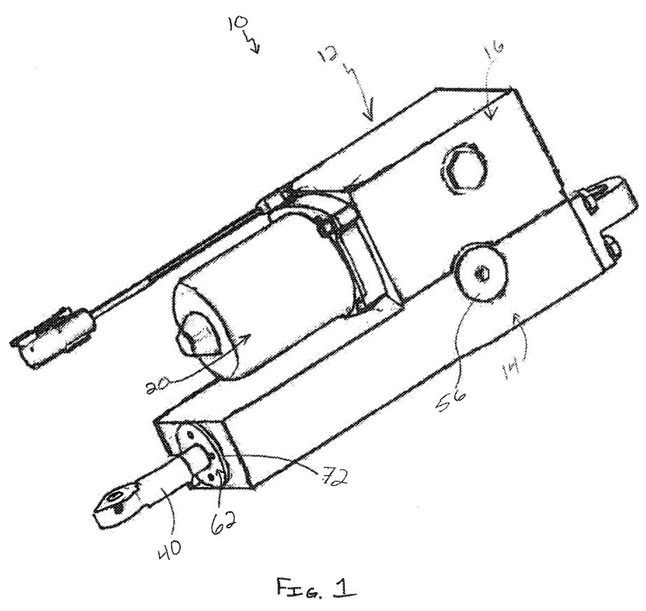

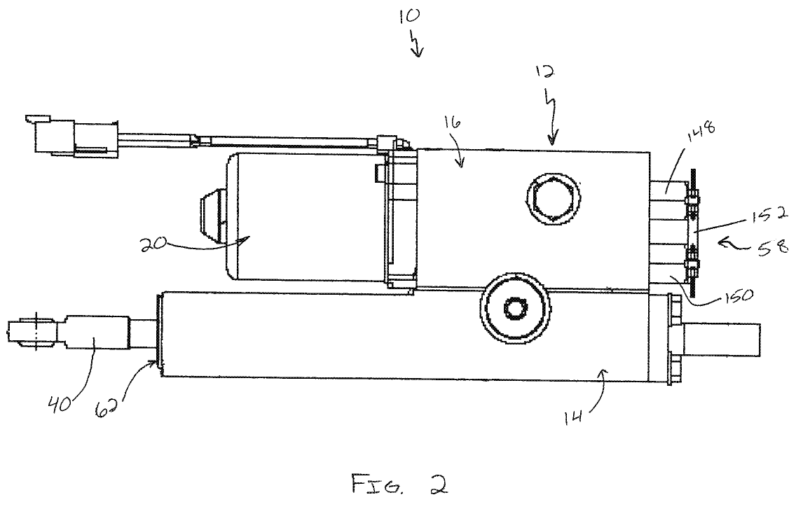

FIG. 1 is a perspective view of an electro-hydraulic actuator 10 constructed in accordance with the present invention. The electro-hydraulic actuator 10 includes a housing 12. In the embodiment illustrated in FIGS. 1 and 2, the housing 12 includes an elongated actuation portion 14 adjacent a shorter drive portion 16. In the illustrated embodiment, the housing 12 is formed as a one-piece, monolithic unit. Alternatively, the housing 12 may be formed from multiple pieces fastened together. For example, the actuation portion 14 and the drive portion 16 may be separate structures that are fastened together and sealed between to form the housing 12. In one embodiment of the invention, the housing is formed from aluminum.

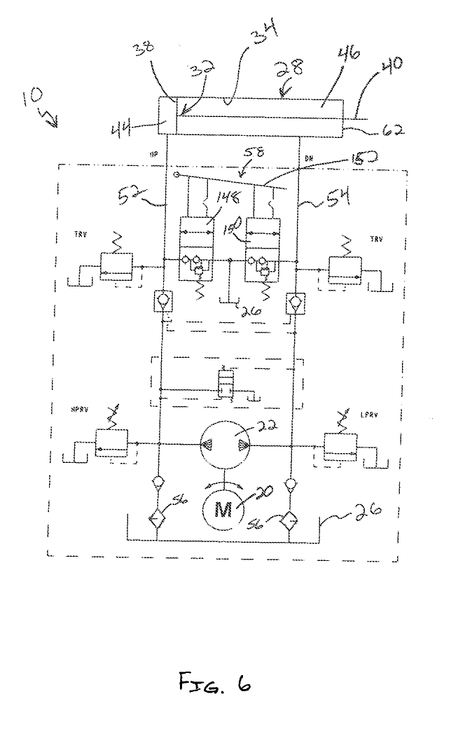

FIG. 6 is a schematic illustration of the electro-hydraulic actuator 10. As illustrated in FIG. 6, the electro-hydraulic actuator 10 includes an electric motor 20 that is operatively coupled to a hydraulic pump 22. The electric motor 20 is operable for driving the hydraulic pump 22 in opposite first and second rotational directions. The hydraulic pump 22 is operable for drawing hydraulic fluid from a reservoir 26 and providing the fluid to an actuator 28. The actuator 28 includes a piston/rod assembly 32 that is located within and is moveable within a cylinder bore 34. The piston/rod assembly 32 includes a piston 38 and a rod 40. The piston/rod assembly 32 may be formed as one-piece or may be formed from multiple pieces secured together. The piston 38 divides the cylinder bore 34 into first and second chambers 44 and 46, respectively. The rod 40 extends through the second chamber 46 and outwardly of the actuator 28.

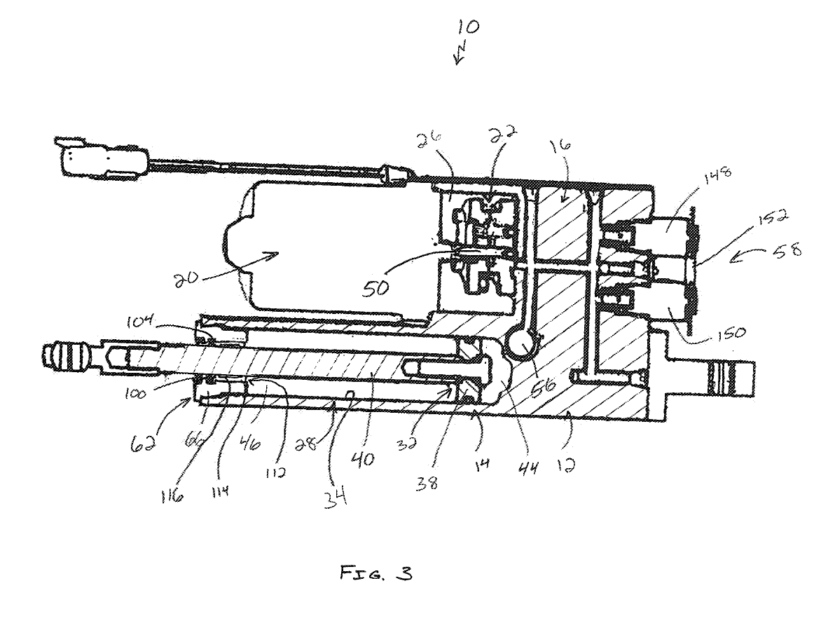

FIG. 3 illustrates a cutaway view of the electro-hydraulic actuator 10 of FIGS. 1 and 2. Although FIG. 3 does not illustrate the components of the electric motor 20, those skilled in the art should recognize that any electric motor may be used. As shown in FIG. 3, the actuation portion 14 of the housing 12 defines the cylinder bore 34. The reservoir 26 is defined within the drive portion 16 of the housing 12. The hydraulic pump 22 is located within the reservoir 26. When the reservoir 26 is filled with hydraulic fluid, the hydraulic pump 22 is submerged in the hydraulic fluid. The hydraulic pump 22 illustrated in FIG. 3 is an external gear pump. Those skilled in the art should recognize that various other types of pumps may be used with the electro-hydraulic actuator 10 of the present invention, for example, internal gear pumps, gerotor pumps, in-line actual piston pumps, and vane pumps. FIG. 3 illustrates a drive shaft of the electric motor 20 extending into the hydraulic pump 22 and acting as the input shaft of the hydraulic pump. Alternatively, the drive shaft 50 of the electric motor 20 may be coupled to a separate input shaft of the hydraulic pump 22 for causing rotation of the hydraulic pump in response to actuation of the electric motor.

FIG. 3 also illustrates a plurality of flow conduits located internally to the housing and extending between the actuation portion 14 and the drive portion 16. When the housing 12 is formed from aluminum, the flow conduits are machined into the housing. The flow conduits, however, may be formed in other ways, such as during casting. The flow conduits of the electro-hydraulic actuator 10 include at least one conduit that connects an output of the hydraulic pump 22 with the first chamber 44 of the actuator 28. This conduit is illustrated schematically in FIG. 6 by reference numeral 52. The flow conduits also include at least one conduit that extends between an outlet of the hydraulic pump 22 and the second chamber 46 of the actuator 28. This conduit is illustrated schematically in FIG. 6 by reference numeral 54. The flow conduits further include a conduit for directing fluid flow from the reservoir 26 to a filter 56 and providing the fluid to an inlet of the hydraulic pump 22. Additional flow conduits are associated with pressure relief valves and a bypass function 58 of the electro-hydraulic actuator 10. The bypass function 58 is described in additional detail below.

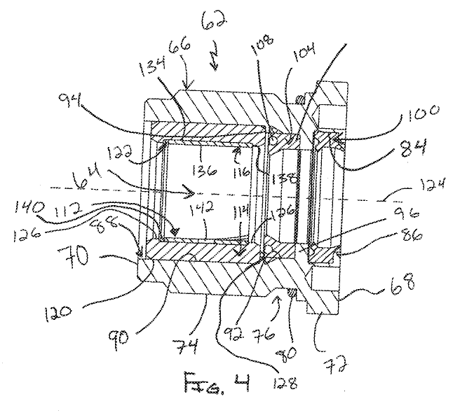

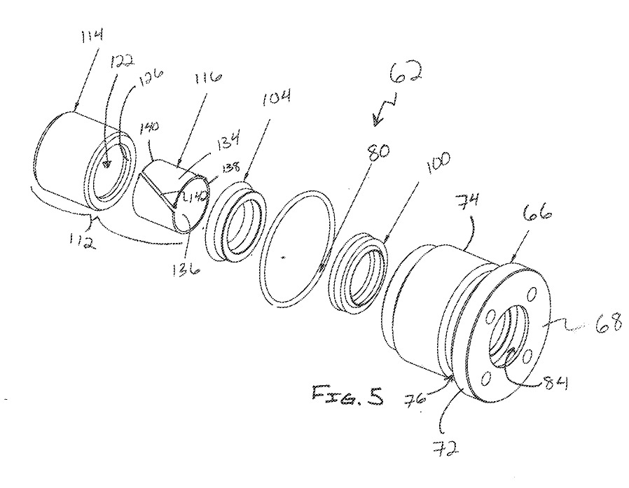

FIG. 3 also illustrates an end cap 62. The end cap 62 closes an open end of the cylinder bore 34 and defines an outer boundary of chamber 46 on a side opposite the piston 38. FIG. 4 illustrates an assembled view of the end cap 62, while FIG. 5 illustrates an exploded, perspective view of the end cap 62. As illustrated in FIG. 4, the end cap 62 includes a through passage 64 through which the rod 40 of the piston/rod assembly 32 extends. The end cap 62 supports the rod 40 for movement relative to the housing 12 and further provides a sealing function for retaining hydraulic fluid in chamber 46. FIG. 3 illustrates the rod 40 extending through the end cap 62.

The electro-hydraulic actuator 10 is operable for extending or retracting the rod 40 relative to the housing 12 for causing relative movement between two structures, one of which is attached to the housing 12 and the other of which is attached to an end of the rod 40. The extend the rod 40, the electric motor 20 is operated to drive the hydraulic pump 22 in a first rotational direction causing hydraulic fluid drawn from the reservoir 26 to be directed into the first chamber 44 of the actuator 28. The fluid directed into the first chamber 44 creates a pressure differential between the first and second chambers of 44 and 46 of the actuators 28 that moves the piston/rod assembly 32 relative to the housing 12 to increase the volume of the first chamber 44 and decrease the volume of the second chamber 46, thus extending the rod 40. To retract the rod 40, the electric motor 20 is operated to drive the hydraulic pump 22 in a second rotational direction, opposite the first rotational direction, causing hydraulic fluid drawn from the reservoir 26 to be directed into the second chamber 46 of the actuator 28. The fluid directed into the second chamber 46 creates a pressure differential between the first and second chambers 44 and 46 of the actuator 28 that moves the piston/rod assembly 32 relative to the housing 12 to increase the volume of the second chamber 46 and decrease the volume of the first chamber 44, thus retracting the rod 40.

The end cap 62 includes a main body portion 66 having opposite first and second ends 68 and 70, respectively. The main body portion 66 of the end cap 62 is generally tubular. An outer surface of the main body portion 66 includes a radially outwardly extending flange portion 72, which is located adjacent the first end 68, and a threaded portion 74, which extends over approximately half the axial length of the main body portion 66. An 0-ring groove 76 is located between the flange portion 72 and the threaded portion 74 on the outer surface of the main body portion 66.

The end cap 62 illustrated in FIGS. 4 and 5 is adapted to be threadedly connected with the actuation portion 14 of the housing 12 of the electro-hydraulic actuator 10. Those skilled in the art should recognize that other methods of securing the end cap 62 to the actuation portion 14 of the housing 12 are contemplated by the present invention. The threaded portion 74 of the main body portion 66 of the end cap 62 engages internal threads (now shown) located on the actuation portion 14 of the housing 12 adjacent an open end of the cylinder bore 34. An O-ring 80 is received in the O-ring groove 76 of the main body portion 66 for sealing between the main body portion 66 and the actuation portion 14 of the housing 12 when the end cap 62 is threadedly connected with the housing. As illustrated in FIG. 1, when the end cap 62 is threadedly connected with the actuation portion 14 of the housing 12, the flange portion 72 of the main body portion 66 of the end cap 62 abuts against an end surface of the actuation portion 14. Typically, the main body portion 66 of the end cap 62 is formed from the same material as the housing 12. Thus, in one embodiment, the main body portion of the end cap 62 is formed from aluminum.

The interior surface of the main body portion 66 of the end cap 62 includes an internal groove 84 located adjacent the first end 68. The integral groove 84 is at least partially defined by a radially extending lip 86 located at the first end 68 of the end cap 62. The interior surface is also partially defined by a stepped counterbore 88 that extends into the second end 70 of the main body portion 66. A large diameter portion of the stepped counterbore 88 is defined by surface 90, while a reduced diameter portion of the stepped counterbore 88 is defined by surface 92. A radially extending shoulder 94 extends between surface 90 and surface 92. Surfaces 90 and 92 define a portion of the interior surface of the main body portion 66. An annular support portion 96 of the main body portion 66 of the end cap 62 defines a bottom of the stepped counterbore 88 and separates the stepped counterbore 88 from the internal groove 84.

The end cap 62 further includes a wiper 100. The wiper is formed from a flexible elastomeric material. As a result, the wiper 100 is easily inserted into the internal groove 84 of the main body portion 66 of the end cap 62. The wiper 100 is retained in the internal groove 84 between lip 86 and support portion 96. The wiper 100 functions to engage in outer surface of the rod 40 to remove debris and other contamination that may be located on the rod prior to the rod being retracted into the housing 12.

The end cap 62 further includes a rod seal 104. The rod seal 104 includes an elastomeric portion 106 and a support portion 108. The elastomeric portion 106 of the rod seal 104 is adapted to engage an outer surface of the rod 40 and to seal between the rod 40 and the main body portion 66 of the end cap. The support portion 108 provides stiffness to the rod seal 104. The support portion 108 may be a metallic ring, for example. The rod seal 104 is designed to withstand the operating pressures of the electro-hydraulic actuator 10 and to prevent hydraulic fluid leakage from chamber 46 out of the housing 12 of the electro-hydraulic actuator 10. When installed in the counterbore 88 of the main body portion 66 of the end cap 62, the rod seal 104 seats against the support portion 96 and against surface 92 of the main body portion.

End cap 62 further includes a rod support portion 112. Rod support portion 112 includes a sleeve 114 and a bushing 116. The sleeve 114 is generally tubular and includes a generally cylindrical outer surface 120 having a diameter slightly larger than a diameter of the stepped bore 88 as defined by surface 90. An interior surface of the sleeve 114 includes a groove 122 having an axially length measured parallel to a centerline 124 (FIG. 4), that is sufficient for receiving the bushing 116. The groove 122 is located between shoulders 126 located on axially opposite ends of the sleeve 114. The sleeve 114 is adapted to be secured within the stepped counterbore 88 of the main body potion 66 of the end cap 62. When the sleeve 114 is received in the counterbore 88, the sleeve 114 acts to secure the rod seal 104 within the counterbore 88. An annular end surface 128 of the sleeve 114 extends between the outer surface 120 and the interior surface of sleeve 114. When the sleeve 114 is received in the counterbore 88, the end surface 128 abuts against shoulder 94 of main body portion 66 and extends radially inwardly toward the centerline 124 a distance sufficient to extend beyond the support portion 108 of the rod seal 104. Thus, as is illustrated in FIG. 4, when assembled in the end cap 62, end surface 128 of the sleeve 114 extends from a location radially outward, relative to centerline 124, of the support portion 108 of the rod seal 104 to a location radially inward of the support portion of the rod seal. Further when received in counterbore 88 of the main body portion 66, the sleeve 114 is spaced a slight distance away from the rod seal 104. This spacing allows slight axial movement, in a direction parallel to centerline 124, of the rod seal 104 within the main body portion 66, while retaining the rod seal 104 in a position for sealing against the rod 40.

The sleeve 114 is formed from a material having an approximately equal coefficient of thermal expansion as the material of the main body portion 66 of the end cap 62. In one embodiment, the sleeve 114 and the main body portion 66 of the end cap 62 are both formed from aluminum. When formed from materials having approximately equal coefficients of thermal expansion, the main body portion 66 and the sleeve 114 are affected by changes in temperature in a similar manner, such as, for example, expanding and contracting at approximately the same rate. Thus, when the sleeve 114 is received in the counterbore 88 of the main body portion 66, such as by being pressed fit within the counterbore, changes in temperature that result in expansion of the main body portion 66 also result in expansion of the sleeve 114 by approximately equal amounts. Changes in temperature that result in contraction of the sleeve 114 also result in contraction of the main body portion 66 of an approximately equal amount. As a result, a bond between the sleeve 114 and surface 90 of the main body portion 66 remains intact and strong during temperature fluctuations, including extremely cold temperatures.

The bushing 116 of the rod support portion 112 is generally tubular and includes a generally cylindrical outer surface 134 and a generally cylindrical inner surface 136. The bushing 116 further includes axially opposite end surfaces 138 and 140. A split 142 (or gap) extends through the bushing 116 between the end surfaces 138 and 140. The split 142 extends completely through the bushing 116 between the inner surface 136 and the outer surface 134. FIG. 5 illustrates an embodiment of the bushing 116 in which the split 142 extends at an angular orientation when extending between opposite end surfaces 138 and 140. The bushing 116 is thinned walled relative to the sleeve 114, meaning that the radial dimension between the outer surface 134 and the inner surface 136 of the bushing is significantly smaller than the radial dimension between the interior surface and the outer surface 120 of the sleeve 114. In the embodiment illustrated in FIG. 4, for example, the bushing 116 has a radial thickness of approximately one-fourth (¼) that of the sleeve 114.

The bushing 116 is formed from a material that is generally resilient. In one embodiment the bushing 116 is formed from nylon. An outer surface 134 of the bushing 116 has a diameter which is greater than the diameter of an interior surface of the sleeve 114 within groove 122. The bushing 116 is adapted to be compressed and, when released, tends to return to its original condition. When compressed, portions of the bushing 116 on opposite sides of the split 142 come together to reduce the outer diameter of the bushing 116.

The bushing 116 is received in the groove 122 of the sleeve 114. To position the bushing 116 in the groove 122 of the sleeve 114, the bushing 116 is compressed and is inserted through an open end of the sleeve 114. When the bushing 116 aligns with the groove 122, the bushing 116 tends to expand back to its original (non-compressed) condition and is snap fit into the groove 122 and against the interior surface of the sleeve 114. Due to the fact that the bushing 116 has a diameter which is greater than the diameter of an interior surface of the sleeve 114 within groove 122, the bushing 116 does not return to its original condition when in the groove 122 and, instead, remains under compression. As a result, the bushing 116 tends to press radially outwardly, relative to the centerline 124, against the sleeve 114. By remaining under compression while in the sleeve 114, the bushing 116 compensates for any changes in the dimensions of the sleeve 114 that result from changes in temperature. If, for example, the sleeve 114 shrinks (or contracts) due to extremely cold temperatures, the bushing 116 is compressed an additional amount by this shrinking and remains in position relative to the sleeve 114. If, for example, the sleeve 114 expands due to increased temperatures, the bushing 116 expands slightly, while remaining under compression, to compensate for the changed dimensions. As a result, the bushing 116 remains in position relative to the sleeve 114 regardless of temperature changes.

When the rod 40 of the piston/rod assembly 32 extends through the end cap 62, the outer surface of the rod 40 engages the inner surface 136 of the bushing 116 and the elastomeric portion 106 of the rod seal 104. The inner surface 136 of the bushing 116 has a low friction finish to minimize friction as the rod 40 is extended out or retracted into the housing 12. The bushing 116, in combination with the sleeve 114, supports the rod 40 when the rod is subjected to side loading conditions.

With reference again to FIG. 6, the electro-hydraulic actuator 10 may further include a bypass function 58. The bypass function 58 illustrated in FIG. 6 includes first and second valves 148 and 150, respectively. The first valve 148 is in fluid communication with flow conduit 52 and with reservoir 26. When in a closed condition, as illustrated in FIG. 6, fluid flow from conduit 52 into reservoir 26 is prevented. Valve 148 is actuatable from a closed condition to an open condition. When in the open condition, fluid flow may pass through valve 148 from conduit 52 to the reservoir 26. The flow passage through valve 148, when in the open condition, enables fluid to exit chamber 44 of the actuator 28 and flow to reservoir 26. As a result, the piston/rod assembly 32 may be moved in a direction for decreasing the volume of chamber 44.

In a manner similar to that described with reference to valve 148, valve 150 is in fluid communication with flow conduit 54 and with reservoir 26. When in a closed condition, as illustrated in FIG. 6, fluid flow from conduit 54 into reservoir 26 is prevented. Valve 150 is actuatable from a closed condition to an open condition. When in the open condition, fluid flow may pass through valve 150 from conduit 54 to the reservoir 26. The flow passage through valve 150, when in the open condition, enables fluid to exit chamber 46 of the actuator 28 and flow to reservoir 26. As a result, the piston/rod assembly 32 may be moved in a direction for decreasing the volume of chamber 46.

FIG. 6 illustrates valves 148 and 150 being connected together by a lever mechanism 152. The lever mechanism 152 simultaneously opens valves 148 and 150. Valves 148 and 150 may be manually actuated or, alternatively, may be actuated by other means such as by an electronic or hydraulic actuator. Actuating valves 148 and 150 into an open condition enables the piston/rod assembly 32 to be moved manually, or by any other means, for increasing and decreasing the volumes of chambers 44 and 46. When valves 148 and 150 are in a closed condition, manual movement of the piston/rod assembly 32 is resisted by fluid pressure within chambers 44 and 46.

Although the principles, embodiments and operation of the present invention have been described in detail herein, this is not to be construed as being limited to the particular illustrative forms disclosed. It will thus become apparent to those skilled in the art that various modifications of the embodiments herein can be made without departing from the scope of the invention.

What is claimed is:

1. An electro-hydraulic actuator comprising:
a hydraulic pump;
an electric motor operable for driving the hydraulic pump;
a piston/rod assembly that is movable in response to fluid from the hydraulic pump;
a housing, a portion of the housing defining a cylinder bore within which a piston of the piston/rod assembly is located; and
an end cap for closing an end of the cylinder bore and through which a rod of the piston/rod assembly extends, the end cap including a bushing for supporting movement of the rod through the end cap, the bushing having an axially extending split and adapted to be under compression when installed in the end cap.

2. The electro-hydraulic actuator of claim 1 wherein the end cap further includes a sleeve for supporting the bushing, the bushing when received in the sleeve tending to press outwardly against the sleeve.

3. The electro-hydraulic actuator of claim 2 wherein the end cap and the sleeve are formed from materials having approximately equal coefficients of thermal expansion.

4. The electro-hydraulic actuator of claim 3 wherein the end cap and the sleeve are formed from the same material.

5. The electro-hydraulic actuator of claim 4 wherein the end cap and the sleeve are both aluminum.

6. The electro-hydraulic actuator of claim 5 wherein the bushing is nylon.

7. The electro-hydraulic actuator of claim 2 wherein the sleeve includes an internal groove adapted for receiving the bushing, the internal groove having a diameter that is smaller than an outer diameter of the bushing when the bushing is in a non-compressed condition.

8. The electro-hydraulic actuator of claim 2 wherein a bore extends into one end of the end cap, a rod seal for sealing against the rod is located in the bore, the sleeve being received in the bore and securing the rod seal in the bore.

9. The electro-hydraulic actuator of claim 8 wherein the sleeve is press fit in the bore of the end cap.

10. The electro-hydraulic actuator of claim 8 wherein the end cap further includes an internal groove located adjacent an end opposite the bore, a wiper for engaging the rod being receivable in the internal groove.

11. The electro-hydraulic actuator of claim 1 wherein the hydraulic pump is located within the housing, fluid conduits between the hydraulic pump and the cylinder bore extending through the housing.

12. The electro-hydraulic actuator of claim 1 wherein another portion of the housing defines a fluid reservoir within the housing, the hydraulic pump being located in the fluid reservoir.

13. The electro-hydraulic actuator of claim 12 further including a plurality of fluid conduits located in the housing, the housing including a bore that intersects at least one of the fluid conduits and is adapted to receive a filter for filtering fluid passing from the reservoir to the hydraulic pump.

14. The electro-hydraulic actuator of claim 12 wherein a further portion of the housing is adapted to support the electric motor such that an output shaft of the electric motor extends into the reservoir for driving the hydraulic pump.

15. The electro-hydraulic actuator of claim 1 wherein the piston divides the cylinder bore into first and second chambers, a first valve actuatable for connecting the first chamber to a reservoir for enabling manual movement of the piston/rod assembly in a direction for decreasing the volume of the first chamber.

16. The electro-hydraulic actuator of claim 15 further including a second valve actuatable for connecting the second chamber to the reservoir for enabling manual movement of the piston/rod assembly in a direction for decreasing the volume of the second chamber.

17. The electro-hydraulic actuator of claim 16 further including a mechanism that interconnects the first and second valves for enabling the first and second valves to be actuated simultaneously.
